(19) United States
(12) Patent Application Publication
(10) Pub. No.: US 2006/0172106 A1
(43) Pub. Date: Aug. 3, 2006

(54) Laminating element

(76) Inventor: Guido Peleman, Puurs (BE)

Correspondence Address: BACON & THOMAS, PLLC, 625 SLATERS LANE, FOURTH FLOOR, ALEXANDRIA, VA, 22314, US

(21) Appl. No.: 11/340,558

(22) Filed: Jan. 27, 2006

(30) Foreign Application Priority Data
Feb. 1, 2005 (BE) 2005/0055

(51) Int. Cl. B32B 3/00

(52) U.S. Cl. 428/57; 428/192; 428/194

(57) ABSTRACT

Improved laminating element which mainly consists of two lamination foils (2) which are connected to each other on at least one side edge, characterized in that the laminating element (1) is provided with a strip (3) made of a flexible material on at least one side edge.

### BACKGROUND OF THE INVENTION

1. Field of the Invention

The present invention concerns an improved laminating element.

2. Discussion of the Related Art

A laminating element for laminating a document is already known, which element consists of two adjacent plastic foils or so-called lamination foils, which are fused together on one side edge.

The dimensions of such a known laminating element are such that, when the above-mentioned plastic foils are provided on either side against the document to be laminated, the edges of these foils extend some 4 to 5 millimeter over the entire circumferential edge of the document to be laminated, past this circumferential edge.

Before the lamination, the document to be laminated is provided between the above-mentioned foils, after which pressure is exerted on the whole in the known manner, at an increased temperature, as a result of which the protruding edges of the foils can be fastened together, such that a rigid whole is formed which is protected on either side against grease, dirt, moisture and the like.

Such a known laminating element is particularly suitable to be used for laminating photo's which have been printed with a conventional color printer, since it provides a gloss finish, which results in a photo of high quality.

A disadvantage of such a known laminating element is that, in case this document has been bound in the known manner in a binding back, it will be difficult to leaf through this document as the laminated document is very stiff.

Since photographic paper is already relatively stiff as such, also when non-laminated photos are bound directly in a binding back, a whole will be formed which is difficult to leaf through, whereby these photos are moreover exposed to grease, dirt and moisture.

Laminating photos is disadvantageous in that an even stiffer whole is formed which is difficult to fold as soon as it has been bound in a binding back.

### SUMMARY OF THE INVENTION

The present invention aims a device for laminating a document, which device is also particularly well fit to be bound, without thereby hindering any leafing through it.

To this end, the invention concerns an improved laminating element which mainly consists of two lamination foils which are connected to each other on at least one side edge, whereby the laminating element is provided with a strip made of a flexible material on at least one side edge.

Such an improved laminating element according to the invention is advantageous in that it becomes possible to bind the laminated document with the above-mentioned flexible strip, such that turning the bound, laminated documents is not hindered by their stiffness.

In a preferred embodiment of an improved laminating element according to the invention, the above-mentioned strip made of flexible material is provided at least partly between two opposite side edges of the above-mentioned lamination foils, and this strip is fixed to the laminating element through lamination, such that it extends partly outside the above-mentioned lamination foils.

This is advantageous in that a solid connection is realized between the flexible strip on the one hand, and the lamination foils on the other hand, without any addition of glue or the like.

### BRIEF DESCRIPTION OF THE DRAWINGS

In order to better explain the characteristics of the present invention, the following preferred embodiment of an improved laminating element according to the invention is given as an example only without being limitative in any way, with reference to the accompanying drawings, in which:

FIG. 1 schematically represents an improved laminating element according to the invention in perspective;

FIG. 2 represents a section according to line II-II in FIG. 1;

FIG. 3 represents a bundle of bound laminating elements according to the invention;

FIG. 4 represents a section according to line IV-IV in FIG. 3.

### DESCRIPTION OF THE PREFERED EMBODIMENT

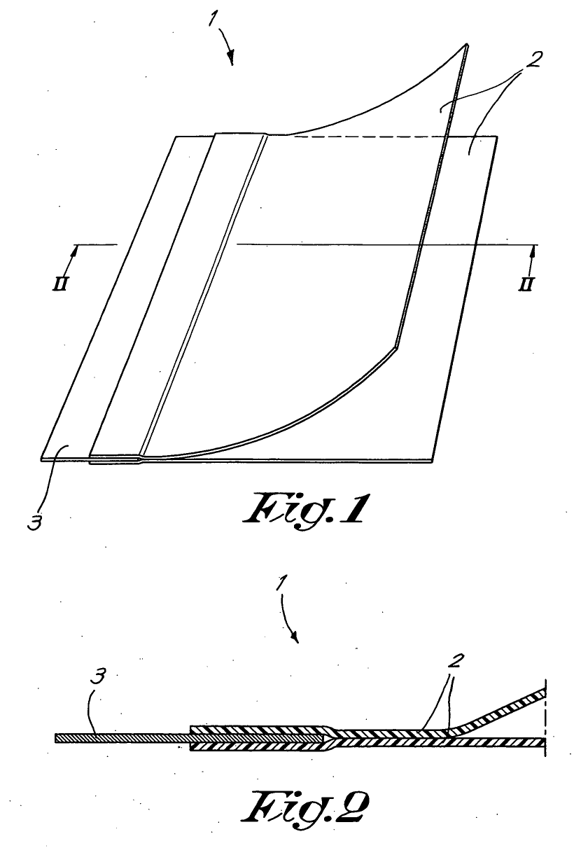

FIGS. 1 and 2 represent an improved laminating element 1 according to the invention which mainly consists of two plastic lamination foils 2 and of a strip 3 made of flexible material fixed to one side edge of the laminating element 1, in this case as this strip 3 is provided over a certain width between the edges of the lamination foils 2 and has been subsequently laminated in between them.

In this case, the above-mentioned strip 3 is hereby fixed to the laminating element 1 in such a manner that it extends partly outside the above-mentioned lamination foils 2.

In this manner is formed a solid connection between the above-mentioned strip 3 on the one hand, and the respective lamination foils 2 on the other hand, without having to use any glue or the like.

The above-mentioned strip 3 preferably but not necessarily extends past the edges of the respective lamination foils 2 over a distance between one and twenty millimeter.

In this case, the above-mentioned strip 3 is made of a material that can be laminated.

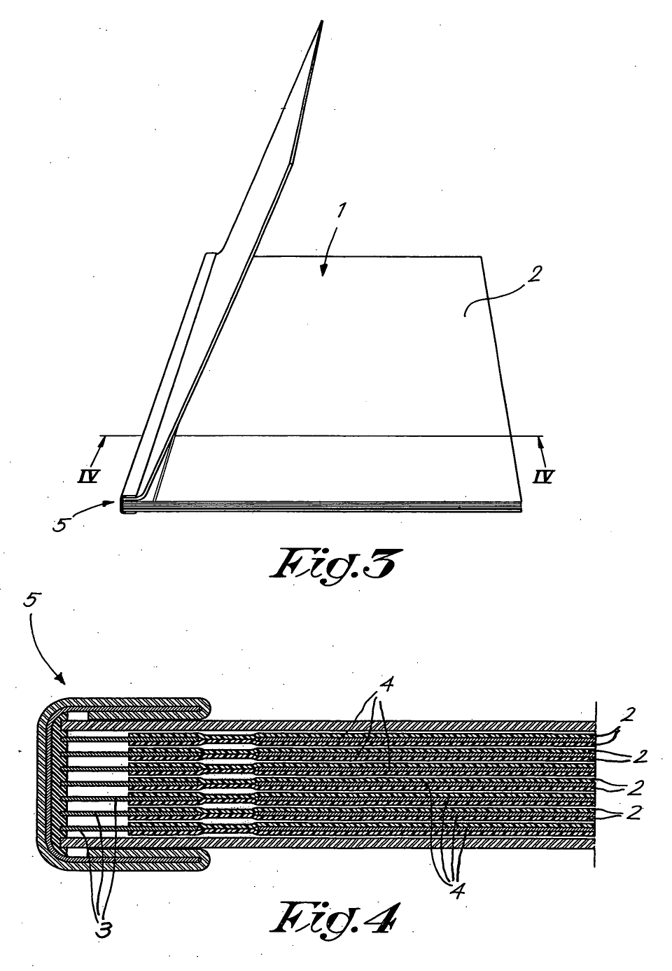

The use of an improved laminating element 1 according to the invention is very simple and is represented in FIGS. 3 and 4.

In order to laminate a sheet 4 or the like, this sheet 4 is provided between the lamination foils 2, such that the lamination foils 2 extend over the entire circumferential edge of the sheet 4 past said edge.

Next, pressure is exerted in the known manner, at an increased temperature, on the above-mentioned lamination foils 2, such that a laminated whole is obtained.

Finally, this laminating element 1 can be bound in a file or the like or in a binding back 5 by means of the above-mentioned flexible strip 3, for example by means of a melting glue which is provided in the above-mentioned binding back 5.

In the latter case, the flexible strip 3 is preferably made of a material such as paper or the like to that end, which adheres well to the glue that is used.

In this manner can be realized a bound bundle of laminated documents, for example in the form of a photo album, a menu, a scrapbook or the like, whereby the stiff sheets can nevertheless be easily turned thanks to the presence of the above-mentioned flexible strip 3.

It is clear that the flexible strip 3 can be fixed to the laminating element 1 in many ways, for example by means of adhesive tape or glue, through mechanical means such as for example stapling or the like, or by a deformation of the flexible strip 3 and the laminating element 1.

It goes without saying that the above-mentioned flexible strip 3 can only be fixed to one of the lamination foils 2 by means of one or several of the above-mentioned or other fixing methods.

In the given example, the flexible strip 3 extends over the entire width of the laminating element 1; however, it is clear that it can only extend over a part thereof or that it can be made even wider.

It is not excluded according to the invention that the above-mentioned strip 3 extends entirely between the lamination foils 2.

The present invention is by no means restricted to the embodiments given as an example and represented in the accompanying drawings; on the contrary an improved laminating element 1 according to the invention can be made in all sorts of shapes and dimensions while still remaining within the scope of the invention.

1. An improved laminating element, comprising two lamination foils which are connected to each other along at least one side edge, wherein the laminating element is provided with a strip made of a flexible material on at least one side edge.

2. The improved laminating element according to claim 1, wherein the strip of is provided at least partly between two opposite side edges of said lamination foils.

3. The improved laminating element according to claim 2, wherein the strip extends entirely between said lamination foils.

4. The improved laminating element according to claim 1, wherein the strip is fixed to the laminating element by means of glue.

5. The improved laminating element according to claim 1, wherein the strip is fixed to the laminating element by means of adhesive tape.

6. The improved laminating element according to claim 1, wherein the strip is fixed to the laminating element by means of mechanical means.

7. The improved laminating element according to claim 1, wherein the strip is made of a material which adheres well in glue.

8. The improved laminating element according to claim 1, wherein the strip is made of a material which can be laminated.

9. The improved laminating element according to claim 8, wherein the strip is fixed to the laminating element by means of lamination.

10. The improved laminating element according to claim 1, wherein the strip is made of paper.

11. The improved laminating element according to claim 1, wherein the strip extends over the entire width of the laminating element.

12. The improved laminating element according to claim 1, wherein the strip extends over a length of one to twenty millimeter beyond the side edge of the lamination foils.
